(19) United States
(12) Patent Application Publication
(10) Pub. No.: US 2025/0286839 A1
(43) Pub. Date: Sep. 11, 2025

(54) SYSTEM AND METHOD FOR MESSAGING

(71) Applicant: 17LIVE Japan Inc., Tokyo (JP)

(72) Inventors: Po-Kao TSENG, Taipei City (TW); Yu-Cheng FAN, Taipei City (TW); Shao-Tang CHIEN, Taipei City (TW)

(21) Appl. No.: 19/068,353

(22) Filed: Mar. 3, 2025

(30) Foreign Application Priority Data
Mar. 5, 2024 (JP) 2024-032721

(51) Int. Cl. H04L 51/04; G06F 3/04842; G06F 40/166; H04N 21/2187

(52) U.S. Cl. CPC H04L 51/04; G06F 3/04842; G06F 40/166; H04N 21/2187

(57) ABSTRACT

The present disclosure relates to a system and a method for messaging. The method includes: obtaining a message from a first user; enabling the first user to amend a portion of the message to generate an amended message; and displaying the amended message to a second user, wherein the message is not displayed to the second user before the portion of the message is amended by the first user.

### The present disclosure relates to stream distribution and, more particularly, to live stream distribution.

### BACKGROUND

Real time interaction on the Internet, such as live streaming service, has become popular in our daily life. There are various platforms or providers providing the service of live streaming, and the competition is fierce. It is important for a platform to provide its users their desired services.

Chinese patent application publication CN111294607A discloses a system for message correction.

### SUMMARY

A method according to one embodiment of the present disclosure is a method for messaging being executed by one or a plurality of computers, and includes: obtaining a message from a first user; enabling the first user to amend a portion of the message to generate an amended message; and displaying the amended message to a second user, wherein the message is not displayed to the second user before the portion of the message is amended by the first user.

A system according to one embodiment of the present disclosure is a system for messaging that includes one or a plurality of processors, and the one or plurality of computer processors execute a machine-readable instruction to perform: obtaining a message from a first user; enabling the first user to amend a portion of the message to generate an amended message; and displaying the amended message to a second user, wherein the message is not displayed to the second user before the portion of the message is amended by the first user.

A non-transitory computer-readable medium including a program for messaging, wherein the program causes one or a plurality of computers to execute: obtaining a message from a first user; enabling the first user to amend a portion of the message to generate an amended message; and displaying the amended message to a second user, wherein the message is not displayed to the second user before the portion of the message is amended by the first user.

### BRIEF DESCRIPTION OF THE DRAWINGS

FIG. 1 shows a schematic configuration of a live streaming system 1 according to some embodiments of the present disclosure.

FIG. 2 is a block diagram showing functions and configuration of the user terminal 30 of FIG. 1 according to some embodiments of the present disclosure.

FIG. 3 shows a block diagram illustrating functions and configuration of the server of FIG. 1 according to some embodiments of the present disclosure.

FIG. 4 is a data structure diagram of an example of the stream DB 310 of FIG. 3.

FIG. 5 is a data structure diagram showing an example of the user DB 312 of FIG. 3.

FIG. 6 is a data structure diagram showing an example of the gift DB 314 of FIG. 3.

FIG. 8 is a data structure diagram showing an example of the behavior DB 332.

FIG. 9 is a data structure diagram showing an example of the ML DB 334.

FIG. 10 shows an exemplary flow according to some embodiments of the present disclosure.

FIG. 11 shows an example of comment correction according to some embodiments of the present disclosure.

FIG. 12 shows an example of comment correction according to some embodiments of the present disclosure.

FIG. 13 shows an example of comment correction according to some embodiments of the present disclosure.

FIG. 14 is a block diagram showing an example of a hardware configuration of the information processing device according to some embodiments of the present disclosure.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

A streaming platform would like to keep the atmosphere or the environment in its stream rooms friendly and positive. Therefore, some negative or offensive comments from users may be controlled or prohibited. However, if a user accidentally makes an inappropriate comment, it is desired to have a friendly or convenient mechanism for the user to amend the comment.

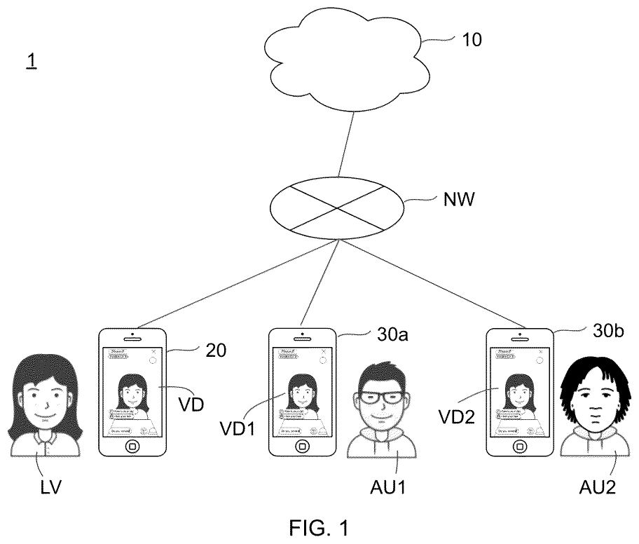

FIG. 1 shows a schematic configuration of a live streaming system I according to some embodiments of the present disclosure. The live streaming system 1 provides a live streaming service for the streaming streamer (could be referred to as liver, anchor, distributor, or livestreamer) LV and viewer (could be referred to as audience) AU (AU1, AU2 . . . ) to interact or communicate in real time. As shown in FIG. 1, the live streaming system 1 includes a server 10, a user terminal 20 and user terminals 30 (30a, 30b . . . ). In some embodiments, the streamers and viewers may be collectively referred to as users. The server 10 may include one or a plurality of information processing devices connected to a network NW. The user terminal 20 and 30 may be, for example, mobile terminal devices such as smartphones, tablets, laptop PCs, recorders, portable gaming devices, and wearable devices, or may be stationary devices such as desktop PCs. The server 10, the user terminal 20 and the user terminal 30 are interconnected so as to be able to communicate with each other over the various wired or wireless networks NW.

The live streaming system 1 involves the distributor LV, the viewers AU, and an administrator (or an APP provider, not shown) who manages the server 10. The distributor LV is a person who broadcasts contents in real time by recording the contents with his/her user terminal 20 and uploading them directly or indirectly to the server 10. Examples of the contents may include the distributor's own songs, talks, performances, gameplays, and any other contents. The administrator provides a platform for live-streaming contents on the server 10, and also mediates or manages real-time interactions between the distributor LV and the viewers AU. The viewer AU accesses the platform at his/her user terminal 30 to select and view a desired content. During live-streaming of the selected content, the viewer AU performs operations to comment, cheer, or send gifts via the user terminal 30. The distributor LV who is delivering the content may respond to such comments, cheers, or gifts. The response is transmitted to the viewer AU via video and/or audio, thereby establishing an interactive communication.

The term “live-streaming” may mean a mode of data transmission that allows a content recorded at the user terminal 20 of the distributor LV to be played or viewed at the user terminals 30 of the viewers AU substantially in real time, or it may mean a live broadcast realized by such a mode of transmission. The live-streaming may be achieved using existing live delivery technologies such as HTTP Live Streaming, Common Media Application Format, Web Real-Time Communications, Real-Time Messaging Protocol and MPEG DASH. Live-streaming includes a transmission mode in which the viewers AU can view a content with a specified delay simultaneously with the recording of the content by the distributor LV. As for the length of the delay, it may be acceptable for a delay with which interaction between the distributor LV and the viewers AU can be established. Note that the live-streaming is distinguished from so-called on-demand type transmission, in which the entire recorded data of the content is once stored on the server, and the server provides the data to a user at any subsequent time upon request from the user.

The term “video data” herein refers to data that includes image data (also referred to as moving image data) generated using an image capturing function of the user terminals 20 or 30, and audio data generated using an audio input function of the user terminals 20 or 30. Video data is reproduced in the user terminals 20 and 30, so that the users can view contents. In some embodiments, it is assumed that between video data generation at the distributor's user terminal and video data reproduction at the viewer's user terminal, processing is performed onto the video data to change its format, size, or specifications of the data, such as compression, decompression, encoding, decoding, or transcoding. However, the content (e.g., video images and audios) represented by the video data before and after such processing does not substantially change, so that the video data after such processing is herein described as the same as the video data before such processing. In other words, when video data is generated at the distributor's user terminal and then played back at the viewer's user terminal via the server 10, the video data generated at the distributor's user terminal, the video data that passes through the server 10, and the video data received and reproduced at the viewer's user terminal are all the same video data.

In the example in FIG. 1, the distributor LV provides the live streaming data. The user terminal 20 of the distributor LV generates the streaming data by recording images and sounds of the distributor LV, and the generated data is transmitted to the server 10 over the network NW. At the same time, the user terminal 20 displays a recorded video image VD of the distributor LV on the display of the user terminal 20 to allow the distributor LV to check the live streaming contents currently performed.

The user terminals 30a and 30b of the viewers AU1 and AU2 respectively, who have requested the platform to view the live streaming of the distributor LV, receive video data related to the live streaming (may also be herein referred to as “live-streaming video data”) over the network NW and reproduce the received video data to display video images VD1 and VD2 on the displays and output audio through the speakers. The video images VD1 and VD2 displayed at the user terminals 30a and 30b, respectively, are substantially the same as the video image VD captured by the user terminal 20 of the distributor LV, and the audio outputted at the user terminals 30a and 30b is substantially the same as the audio recorded by the user terminal 20 of the distributor LV.

Recording of the images and sounds at the user terminal 20 of the distributor LV and reproduction of the video data at the user terminals 30a and 30b of the viewers AU1 and AU2 are performed substantially simultaneously. Once the viewer AU1 types a comment about the contents provided by the distributor LV on the user terminal 30a, the server 10 displays the comment on the user terminal 20 of the distributor LV in real time and also displays the comment on the user terminals 30a and 30b of the viewers AU1 and AU2, respectively. When the distributor LV reads the comment and develops his/her talk to cover and respond to the comment, the video and sound of the talk are displayed on the user terminals 30a and 30b of the viewers AU1 and AU2, respectively. This interactive action is recognized as the establishment of a conversation between the distributor LV and the viewer AU1. In this way, the live streaming system 1 realizes the live streaming that enables interactive communication, not one-way communication.

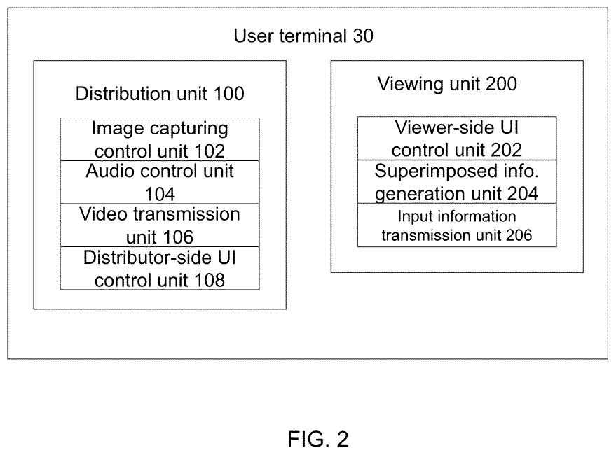

FIG. 2 is a block diagram showing functions and configuration of the user terminal 30 of FIG. 1 according to some embodiments of the present disclosure. The user terminal 20 has the same or similar functions and configuration as the user terminal 30. Each block in FIG. 2 and the subsequent block diagrams may be realized by elements such as a computer CPU or a mechanical device in terms of hardware, and can be realized by a computer program or the like in terms of software. Functional blocks could be realized by cooperative operation between these elements. Therefore, it is understood by those skilled in the art that these functional blocks can be realized in various forms by combining hardware and software.

The distributor LV and the viewers AU may download and install a live streaming application program (hereinafter referred to as a live streaming application) to the user terminals 20 and 30 from a download site over the network NW. Alternatively, the live streaming application may be pre-installed on the user terminals 20 and 30. When the live streaming application is executed on the user terminals 20 and 30, the user terminals 20 and 30 communicate with the server 10 over the network NW to implement or execute various functions. Hereinafter, the functions implemented by the user terminals 20 and 30 (processors such as CPUs) in which the live streaming application is run will be described as functions of the user terminals 20 and 30. These functions are realized in practice by the live streaming application on the user terminals 20 and 30. In some embodiments, these functions may be realized by a computer program that is written in a programming language such as HTML (HyperText Markup Language), transmitted from the server 10 to web browsers of the user terminals 20 and 30 over the network NW, and executed by the web browsers.

The user terminal 30 includes a distribution unit 100 and a viewing unit 200. The distribution unit 100 generates video data in which the user's (or the user side's) image and sound are recorded, and provides the video data to the server 10. The viewing unit 200 receives video data from the server 10 to reproduce the video data. The user activates the distribution unit 100 when the user performs live streaming, and activates the viewing unit 200 when the user views a video. The user terminal in which the distribution unit 100 is activated is the distributor's terminal, i.e., the user terminal that generates the video data. The user terminal in which the viewing unit 200 is activated is the viewer's terminal, i.e., the user terminal in which the video data is reproduced and played.

The distribution unit 100 includes an image capturing control unit 102, an audio control unit 104, a video transmission unit 106, and a distribution-side UI control unit 108. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time. The distribution-side UI control unit 108 controls an UI (user interface) for the distributor. The distribution-side UI control unit 108 may be connected to a display (not shown in FIG. 2), and displays a video on the display by reproducing the video data that is to be transmitted by the video transmission unit 106. The distribution-side UI control unit 108 may display an operation object or an instruction-accepting object on the display. and accepts inputs from the distributor who taps on the object.

The viewing unit 200 includes a viewer-side UI control unit 202, a superimposed information generation unit 204, and an input information transmission unit 206. The viewing unit 200 receives, from the server 10 over the network NW, video data related to the live streaming in which the distributor, the viewer who is the user of the user terminal 30, and other viewers participate. The viewer-side UI control unit 202 controls the UI for the viewers. The viewer-side UI control unit 202 is connected to a display and a speaker (not shown in FIG. 2), and reproduces the received video data to display video images on the display and output audio through the speaker. The state where the image is outputted to the display and the audio is outputted from the speaker can be referred to as “the video data is played”. The viewer-side UI control unit 202 is also connected to input means (not shown in FIG. 2) such as touch panels, keyboards, and displays, and obtains user input via these input means. The superimposed information generation unit 204 superimposes a predetermined frame image on an image generated from the video data from the server 10. The frame image includes various user interface objects (hereinafter simply referred to as “objects”) for accepting inputs from the user, comments entered by the viewers, and/or information obtained from the server 10. The input information transmission unit 206 transmits the user input obtained by the viewer-side UI control unit 202 to the server 10 over the network NW.

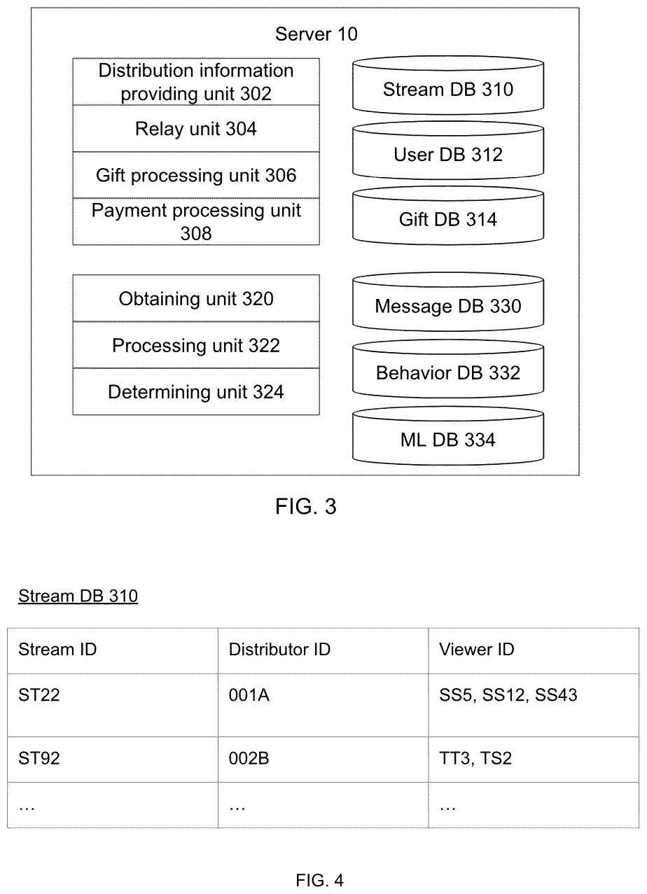

FIG. 3 shows a block diagram illustrating functions and configuration of the server 10 of FIG. 1 according to some embodiments of the present disclosure. The server 10 includes a distribution information providing unit 302, a relay unit 304, a gift processing unit 306, a payment processing unit 308, a stream DB 310, a user DB 312, a gift DB 314, an obtaining unit 320, a processing unit 322, a determining unit 324, a message DB 330, a behavior DB 332, and a ML DB 334.

Upon reception of a notification or a request from the user terminal 20 on the distributor side to start a live streaming over the network NW, the distribution information providing unit 302 registers a stream ID for identifying this live streaming and the distributor ID of the distributor who performs the live streaming in the stream DB 310.

When the distribution information providing unit 302 receives a request to provide information about live streams from the viewing unit 200 of the user terminal 30 on the viewer side over the network NW, the distribution information providing unit 302 retrieves or checks currently available live streams from the stream DB 310 and makes a list of the available live streams. The distribution information providing unit 302 transmits the generated list to the requesting user terminal 30 over the network NW. The viewer-side UI control unit 202 of the requesting user terminal 30 generates a live stream selection screen based on the received list and displays it on the display of the user terminal 30.

Once the input information transmission unit 206 of the user terminal 30 receives the viewer's selection result on the live stream selection screen, the input information transmission unit 206 generates a distribution request including the stream ID of the selected live stream, and transmits the request to the server 10 over the network NW. The distribution information providing unit 302 starts providing, to the requesting user terminal 30, the live stream specified by the stream ID included in the received distribution request. The distribution information providing unit 302 updates the stream DB 310 to include the user ID of the viewer of the requesting user terminal 30 into the viewer IDs of (or corresponding to) the stream ID.

The relay unit 304 relays the video data from the distributor-side user terminal 20 to the viewer-side user terminal 30 in the live streaming started by the distribution information providing unit 302. The relay unit 304 receives from the input information transmission unit 206 a signal that represents user input by a viewer during the live streaming or reproduction of the video data. The signal that represents user input may be an object specifying signal for specifying an object displayed on the display of the user terminal 30. The object specifying signal may include the viewer ID of the viewer, the distributor ID of the distributor of the live stream that the viewer watches, and an object ID that identifies the object. When the object is a gift, the object ID is the gift ID. Similarly, the relay unit 304 receives, from the distribution unit 100 of the user terminal 20, a signal that represents user input performed by the distributor during reproduction of the video data (or during the live streaming). The signal could be an object specifying signal.

Alternatively, the signal that represents user input may be a comment input signal including a comment entered by a viewer into the user terminal 30 and the viewer ID of the viewer. Upon reception of the comment input signal, the relay unit 304 transmits the comment and the viewer ID included in the signal to the user terminal 20 of the distributor and the user terminals 30 of other viewers. In these user terminals 20 and 30, the viewer-side UI control unit 202 and the superimposed information generation unit 204 display the received comment on the display in association with the viewer ID also received.

The gift processing unit 306 updates the user DB 312 so as to increase the points of the distributor depending on the points of the gift identified by the gift ID included in the object specifying signal. Specifically, the gift processing unit 306 refers to the gift DB 314 to specify the points to be granted for the gift ID included in the received object specifying signal. The gift processing unit 306 then updates the user DB 312 to add the determined points to the points of (or corresponding to) the distributor ID included in the object specifying signal.

The payment processing unit 308 processes payment of a price of a gift from a viewer in response to reception of the object specifying signal. Specifically, the payment processing unit 308 refers to the gift DB 314 to specify the price points of the gift identified by the gift ID included in the object specifying signal. The payment processing unit 308 then updates the user DB 312 to subtract the specified price points from the points of the viewer identified by the viewer ID included in the object specifying signal.

FIG. 4 is a data structure diagram of an example of the stream DB 310 of FIG. 3. The stream DB 310 holds information regarding a live stream currently taking place. The stream DB 310 stores the stream ID, the distributor ID, and the viewer ID, in association with each other. The stream ID is for identifying a live stream on a live streaming platform provided by the live streaming system 1. The distributor ID is a user ID for identifying the distributor who provides the live stream. The viewer ID is a user ID for identifying a viewer of the live stream. In the live streaming platform provided by the live streaming system 1 of some embodiments, when a user starts a live stream, the user becomes a distributor, and when the same user views a live stream broadcast by another user, the user also becomes a viewer. Therefore, the distinction between a distributor and a viewer is not fixed, and a user ID registered as a distributor ID at one time may be registered as a viewer ID at another time.

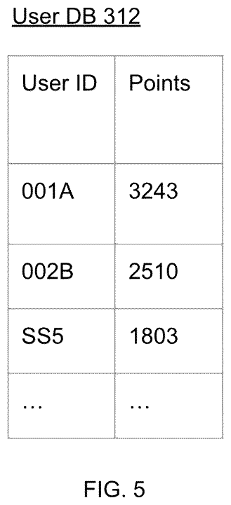

FIG. 5 is a data structure diagram showing an example of the user DB 312 of FIG. 3. The user DB 312 holds information regarding users. The user DB 312 stores the user ID and the point, in association with each other. The user ID identifies a user. The point corresponds to the points the corresponding user holds. The point is the electronic value circulated within the live streaming platform. In some embodiments, when a distributor receives a gift from a viewer during a live stream, the distributor's points increase by the value corresponding to the gift. The points are used, for example, to determine the amount of reward (such as money) the distributor receives from the administrator of the live streaming platform. In some embodiments, when the distributor receives a gift from a viewer, the distributor may be given the amount of money corresponding to the gift instead of the points.

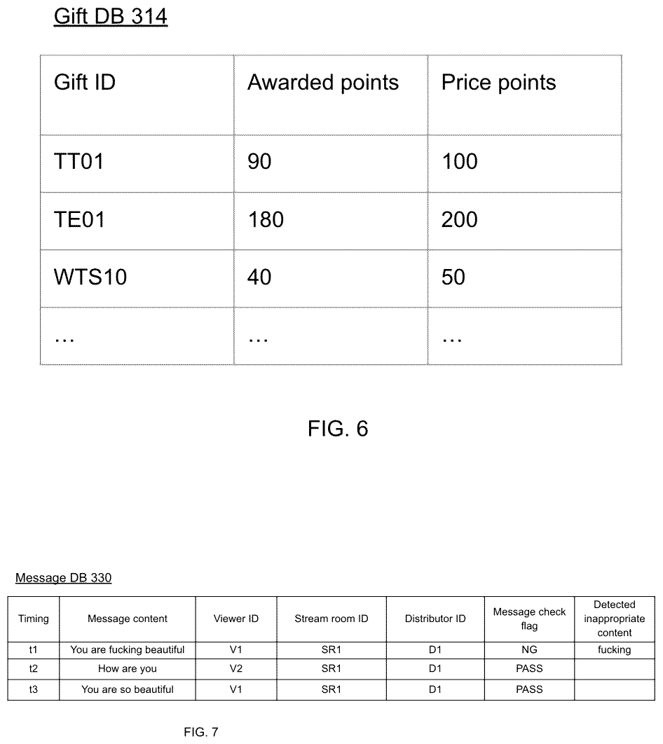

FIG. 6 is a data structure diagram showing an example of the gift DB 314 of FIG. 3. The gift DB 314 holds information regarding gifts available for the viewers in the live streaming. A gift is electronic data. A gift may be purchased with the points or money, or can be given for free. A gift may be given by a viewer to a distributor. Giving a gift to a distributor is also referred to as using, sending, or throwing the gift. Some gifts may be purchased and used at the same time, and some gifts may be purchased and then used at any time later by the purchaser viewer. When a viewer gives a gift to a distributor, the distributor is awarded the amount of points corresponding to the gift. When a gift is used, the use may trigger an effect associated with the gift. For example, an effect (such as visual or sound effect) corresponding to the gift will appear on the live streaming screen.

The gift DB 314 stores the gift ID, the awarded points, and the price points, in association with each other. The gift ID is for identifying a gift. The awarded points are the amount of points awarded to a distributor when the gift is given to the distributor. The price points are the amount of points to be paid for use (or purchase) of the gift. A viewer is able to give a desired gift to a distributor by paying the price points of the desired gift when the viewer is viewing the live stream. The payment of the price points may be made by an appropriate electronic payment means. For example, the payment may be made by the viewer paying the price points to the administrator. Alternatively, bank transfers or credit card payments may be used. The administrator is able to desirably set the relationship between the awarded points and the price points. For example, it may be set as the awarded points=the price points. Alternatively, points obtained by multiplying the awarded points by a predetermined coefficient such as 1.2 may be set as the price points, or points obtained by adding predetermined fee points to the awarded points may be set as the price points.

FIG. 7 is a data structure diagram showing an example of the message DB 330. The message DB 330 stores the timing, the message content, the viewer ID, the stream room ID, the distributor ID, the message check flag, and the inappropriate content, in association with each other.

The timing is the timing (or time span) of receiving the message. The message content is the content of the message (or the comment). The viewer ID corresponds to the viewer who sends the message. The stream room ID corresponds to the stream room wherein the viewer sends the message. The distributor ID corresponds to the distributor of the stream room. In some embodiments, there could be multiple distributors in a stream room (such as in a PK mode or a co-performing mode).

The message check flag corresponds to whether or not the message passes the content check mechanism of the platform. If the message check flag is NG, the message will not be displayed to other users (such as the distributor or other viewers) of the stream room. The message will be displayed to other users of the stream room only when the message check flag is PASS. In some embodiments, the message check mechanism is performed by the processing unit 322.

The detected inappropriate content is the content that is detected, by the processing unit 322, to be inappropriate. The processing unit 322 may utilize the ML DB 334 for the message check process. For example, the processing unit 322 may compare or match (such as text matching, contextual matching, or vector matching) the message with the inappropriate content and the similar contents stored in the ML DB 334.

In this example, at timing t1, viewer V1 inputs the message “You are fucking beautiful”. The message check result is NG because the content “fucking” is detected to be inappropriate. At timing t3, viewer V1 amends the message to “You are so beautiful”, and the message check result is PASS.

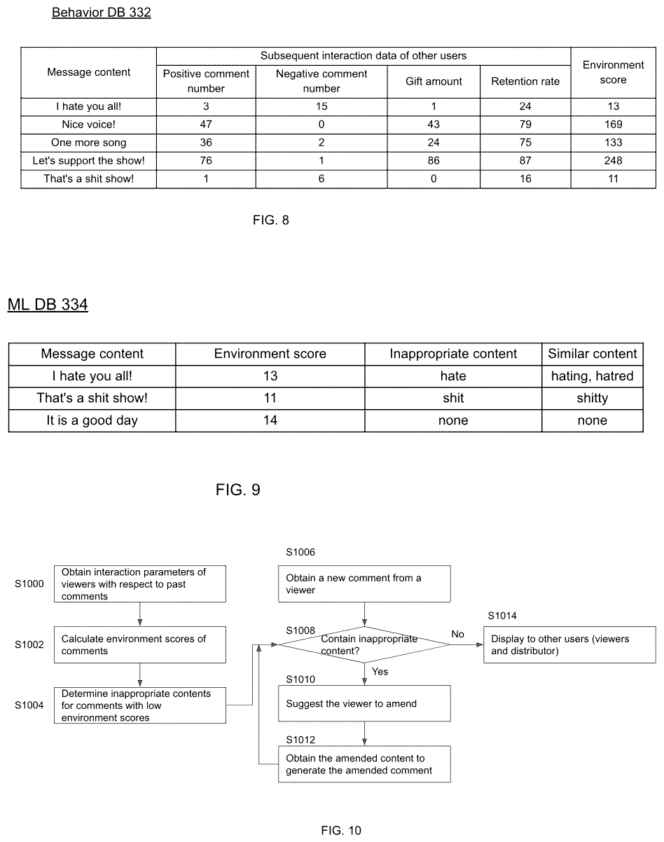

FIG. 8 is a data structure diagram showing an example of the behavior DB 332. The behavior DB 332 stores the message content, the subsequent interaction data of other users, and the environment score, in association with each other.

The subsequent interaction data of other users are the interaction data from other users after the message is sent out by a particular user, and could be calculated within a predetermined time period. The subsequent interaction data indicates how other users react to the message. In some embodiments, the subsequent interaction data of other users could be obtained by obtaining unit 320, from a monitoring unit within or outside server 10.

In this example, the subsequent interaction data of other users include the positive comment number, the negative comment number, the gift amount, and the retention rate. In some embodiments, other interaction parameters could be included. The positive comment number is the number of positive comments from other users. The negative comment number is the number of negative comments from other users. The gift amount is the gift number from other users. The retention rate could be the rate of retention of other users in a time period after the comment is sent.

In some embodiments, whether or not a comment from a user is positive or negative could be determined by a language model or a machine learning model within the ML DB 334 or within server 10. For example, an LLM (large language model) could be utilized. In some embodiments, whether or not a comment from other users is directed to the message content could be determined by a language model or a machine learning model within the ML DB 334 or within server 10.

The environment score indicates how healthy or how friendly it is in a stream room, after a corresponding message is sent in that stream room. The environment score is calculated according to the subsequent interaction data of other users. The environment score may increase with positive interaction data (such as positive comment, gift amount, and retention rate), and may decrease with negative interaction data (such as negative comment). Various calculation methods could be used according to the actual practice. In this example, the environment score is calculated as [positive comment number]+[gift amount]+[retention rate]−[negative comment number]. In some embodiments, the calculation process could be performed by the processing unit 322.

FIG. 9 is a data structure diagram showing an example of the ML DB 334. The ML DB 334 stores the message content, the environment score, the inappropriate content, and the similar content, in association with each other.

In some embodiments, only message contents whose environment scores are less than a threshold value would be put into the ML DB 334. The inappropriate content stores the content portion of the message that's determined to be the reason for the low environment score. The similar content stores contents similar to the inappropriate content.

In some embodiments, the inappropriate content and the similar content could be delivered (or determined) by inputting the message content into a LLM or a machine learning model within the ML DB 334 or within server 10. The process could be performed by the processing unit 322, for example. In some embodiments, neighboring messages of the message content with a low environment score could also be input to the LLM for a more precise determination of the inappropriate content. In some embodiments, the LLM or the machine learning model determines the inappropriate content and the similar contents according to past messages from users on a live stream platform and past interaction data from users corresponding to the past messages.

In some embodiments, a comment with a low environment score does not necessarily contain inappropriate content. In that case, the LLM will not determine an inappropriate content to be included in the comment.

The inappropriate content and the similar content are then used to determine the message check flag for the messages (or new messages) in the message DB 330. For example, the determining unit 324 may determine whether a newly received message contains the inappropriate content (or the similar content) and set the message check flag to NG or PASS. If it's NG, the determining unit 324 may store the matched inappropriate content into the “detected inappropriate content” in the message DB 330. The matched inappropriate content could be shown to the viewer in a notification message, such as shown in FIG. 12, which will be explained later.

The obtaining unit 320 could be configured to obtain messages from users, and/or to obtain values (or contents) in the message DB 330, the behavior DB 332, and the ML DB 334.

The determining unit 324 could be configured to determine whether or not a message includes a content of a predetermined type. For example, the determining unit 324 determines whether or not a message contains the inappropriate content.

The processing unit 322 could be configured to notify a user to remove an inappropriate content in a message, in order to successfully display the amended message to another user. The processing unit 322 could be configured to enable the user to amend a portion of the message to generate the amended message.

For example, the processing unit 322 may display a notification box to the user, indicating that a message (or comment) of the user contains inappropriate content. Once the determining unit 324 determines the user has selected (or tapped, or clicked) the notification box, the processing unit 322 displays a message input interface containing the original message to the user. The user may then amend the message to generate the amended message which does not contain the inappropriate content.

For example, the processing unit 322 may display a user interface to the user, suggesting the user to input an amended content to replace the inappropriate content. The obtaining unit 320 then obtains the amended content from the user. The processing unit then replaces the inappropriate content with the amended content to generate the amended message. Therefore, the user does not need to retype other portions of the message.

FIG. 10 shows an exemplary flow according to some embodiments of the present disclosure.

At step S1000, the obtaining unit 320 obtains interaction parameters of viewers with respect to past comments. Those data could be from various stream rooms on a live stream platform, for example.

At step S1002, the processing unit 322 calculates the environment scores for the comments according to their corresponding interaction data.

At step S1004, the processing unit 322 (or the determining unit 324) determines the inappropriate contents (and their similar contents) for comments with low environment scores, using a LLM, for example. The inappropriate contents and the similar contents are stored into the ML DB 334.

At step S1006, the obtaining unit 320 obtains a new comment from a viewer.

At step S1008, the determining unit 324 determines whether or not the comment includes an inappropriate content (or similar content) by referring to the ML DB 334. If YES, the flow goes to step S1010. If NO, the flow goes to step S1014.

At step S1014, the processing unit 322 displays the comment to the user terminals of other users, such as the distributor and other viewers. The distribution information providing unit 302 and/or the relay unit 304 could be involved in the display process.

At step S1010, the processing unit 322 suggests the viewer to amend the comment due to the inappropriate content detected.

At step S1012, the obtaining unit 320 obtains the amended content to generate the amended comment. The flow then goes back to step S1008 for inappropriate content check.

All or part of the above steps could be done in a real time manner. For example, if a new word (or phrase) in stream room A just caused a lot of negative feedback, the word will immediately be stored as inappropriate content and can be used to prevent the usage of the word in all stream rooms.

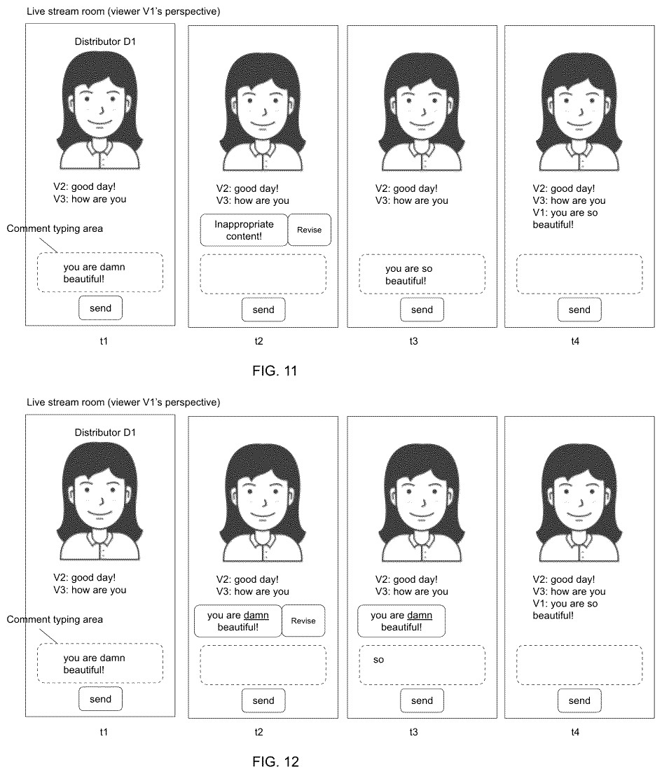

FIG. 11 shows an example of comment correction according to some embodiments of the present disclosure. The user interface is from viewer V1′s perspective in a live stream room of distributor D1.

At timing t1, viewer V1 types the comment and selects “send”.

At timing t2, a notification of inappropriate content is displayed to viewer V1, because the comment does not pass the comment check mechanism. Viewer V1 then selects “Revise”. In some embodiments, the notification indicates the inappropriate content to the viewer. For example, the notification may show “Inappropriate content: damn”, such that the viewer knows clearly what portion to amend.

At timing t3, the original comment is shown in the comment typing area, and viewer V1 corrects a portion of the comment, and then selects “send”. Viewer V1 does not need to retype other portions of the original comment that do not contain the inappropriate content.

At timing t4, the amended comment passes the comment check mechanism and is displayed in the stream room comment area, along with comments of other viewers.

In some embodiments, the original comment will be saved in a temporary memory space within the server until the message is amended by the user.

FIG. 12 shows an example of comment correction according to some embodiments of the present disclosure. The user interface is from viewer V1's perspective in a live stream room of distributor D1.

At timing t1, viewer V1 types the comment and selects “send”.

At timing t2, a notification of inappropriate content is displayed to viewer V1. The notification indicates the inappropriate portion to the viewer. Viewer V1 then selects “Revise”.

At timing t3, viewer V1 only types the amended portion in the comment typing area. The amended portion would be used to replace the inappropriate portion of the original comment, to generate the amended comment. Viewer V1 then selects “send”.

At timing t4, the amended comment passes the comment check mechanism and is displayed in the stream room comment area, along with comments of other viewers.

The present disclosure can automatically update the inappropriate content database in the ML DB 334 by analyzing the interaction data of users in a real time manner. Because new words (or new inappropriate contents) are constantly created on the internet everyday, a timely update of the inappropriate content database and constant monitoring of the comment content on the live stream platform is important. The present disclosure also provides an efficient method for a user to correct the inappropriate content.

In some embodiments, the subsequent interaction data in the behavior DB 332 can include interaction parameters of the distributor. For example, audio data of the distributor can be converted into text data and can be analyzed by the LLM to detect the positive comment or the negative comment of the distributor, with respect to a message from a viewer. The extracted interaction data of the distributor are then used to calculate the environment scores.

The present disclosure can be used to establish the inappropriate content database and to monitor the comment environment, not only in live stream platforms, but also in various comment or messaging services/environments. Any application or website chat room wherein multiple users communicate with each other can utilize the present disclosure to maintain the comment environment.

In some embodiments, the determined inappropriate content can be sent from the server to the user terminals of users. For example, the inappropriate content can be stored into a cache memory on the user terminal of a viewer. Therefore, when the viewer inputs an inappropriate content, the user terminal can detect the inappropriate content, and show the user interface for correction (or partial correction) without the need to send the comment to the server for the comment check.

In some embodiments, when a viewer inputs a comment containing inappropriate content in a live stream room, the comment will be sent out to the user terminals of other viewers but will not be displayed on the user interfaces of those user terminals. The comment will only be displayed (triggered the processing unit 322, for example) on those user interfaces after it is amended. That mechanism enables an administrator user terminal of the platform to monitor or record the users who send inappropriate contents.

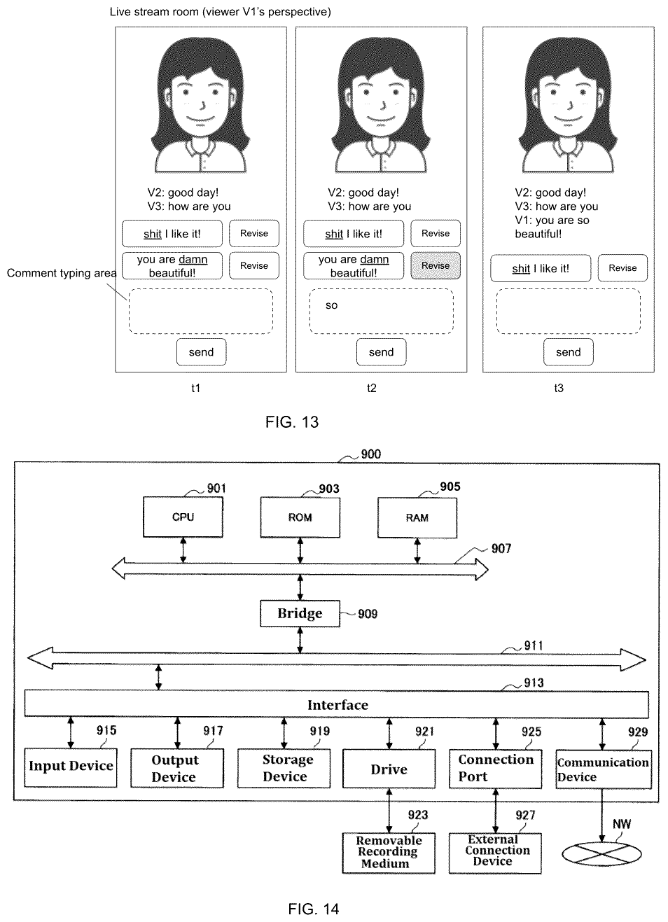

FIG. 13 shows an example of comment correction according to some embodiments of the present disclosure. The user interface is from viewer V1's perspective in a live stream room of distributor D1.

At timing t1, because viewer V1 types too fast and does not notice the inappropriate content notification, viewer V1 types two comments containing inappropriate contents in a straight. There are two notifications about inappropriate contents shown on the user interface.

At timing t2, viewer V1 selects to amend the comment “you are damn beautiful!” which contains the inappropriate content “damn”. Viewer V1 inputs the amended content “so” in the comment typing area.

At timing t3, the amended comment is shown on the comment area of the stream room, and can be seen by other users. Viewer V1 can proceed to partially correct the other message containing the inappropriate content “shift”.

The embodiment enables a viewer to separately correct a portion of each past comment easily, without having to retype other portions of those comments. In some embodiments, if the viewer enters nothing as the amended content, the inappropriate content will be just deleted.

Referring to FIG. 14, the hardware configuration of the information processing device will be now described. FIG. 14 is a block diagram showing an example of a hardware configuration of the information processing device according to some embodiments of the present disclosure. The illustrated information processing device 900 may, for example, realize the server 10 and/or the user terminals 20 and 30 in some embodiments.

The information processing device 900 includes a CPU 901, ROM (Read Only Memory) 903, and RAM (Random Access Memory) 905. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). In addition to or instead of the CPU 901, the information processing device 900 may also include a DSP (Digital Signal Processor) or ASIC (Application Specific Integrated Circuit).

The CPU 901 functions as an arithmetic processing device and a control device, and controls all or some of the operations in the information processing device 900 according to various programs stored in the ROM 903, the RAM 905, the storage device 919, or the removable recording medium 923. For example, the CPU 901 controls the overall operation of each functional unit included in the server 10 and the user terminals 20 and 30 in some embodiments. The ROM 903 stores programs, calculation parameters, and the like used by the CPU 901. The RAM 905 serves as a primary storage that stores a program used in the execution of the CPU 901, parameters that appropriately change in the execution, and the like. The CPU 901, ROM 903, and RAM 905 are interconnected to each other by a host bus 907 which may be an internal bus such as a CPU bus. Further, the host bus 907 is connected to an external bus 911 such as a PCI (Peripheral Component Interconnect/Interface) bus via a bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OLED, etc., a sound output device such as a speaker and headphones, and a printer. The output device 917 outputs the results of processing by the information processing unit 900 as text, video such as images, or sound such as audio.

The storage device 919 is a device for storing data configured as an example of a storage unit of the information processing equipment 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for a removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 905. Further, the drive 921 writes records in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is an imaging element such as a CCD (Charge Coupled Device) or CMOS (Complementary Metal Oxide Semiconductor), and a device that captures an image of the real space using various elements such as lenses for controlling image formation of a subject on the imaging clement to generate the captured image. The image capturing device may capture a still image or may capture a moving image.

The configuration and operation of the live streaming system 1 in the embodiment have been described. This embodiment is a mere example, and it is understood by those skilled in the art that various modifications are possible for each component and a combination of each process, and that such modifications are also within the scope of the present disclosure.

The processing and procedures described in the present disclosure may be realized by software, hardware, or any combination of these in addition to what was explicitly described. For example, the processing and procedures described in the specification may be realized by implementing a logic corresponding to the processing and procedures in a medium such as an integrated circuit, a volatile memory, a non-volatile memory, a non-transitory computer-readable medium and a magnetic disk. Further, the processing and procedures described in the specification can be implemented as a computer program corresponding to the processing and procedures, and can be executed by various kinds of computers.

Furthermore, the system or method described in the above embodiments may be integrated into programs stored in a computer-readable non-transitory medium such as a solid state memory device, an optical disk storage device, or a magnetic disk storage device. Alternatively, the programs may be downloaded from a server via the Internet and be executed by processors.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed, but includes another variation and modification that do not disobey the present disclosure, and is the scope covered by the patent application scope.

### DESCRIPTION OF REFERENCE NUMERALS

1 communication system
10 server
20 user terminal
30, 30a, 30b user terminal
LV distributor
AU1, AU2 viewer
VD, VD1, VD2 video image
NW network
30 user terminal
100 distribution unit
102 image capturing control unit
104 audio control unit
106 video transmission unit
108 distributor-side UI control unit
200 viewing unit
202 viewer-side UI control unit
204 superimposed information generation unit
206 input information transmission unit
302 distribution information providing unit
304 relay unit
306 gift processing unit
308 payment processing unit
310 stream DB
312 user DB
314 gift DB
320 obtaining unit
322 processing unit
324 determining unit
330 message DB
332 behavior DB
334 ML DB
900 information processing device
901 CPU
903 ROM
905 RAM
907 host bus
909 bridge
911 external bus
913 interface
915 input device
917 output device
919 storage device
921 drive
923 removable recording medium
925 connection port
927 external connection device
929 communication device

We claim:

1. A method for messaging, executed by a server, comprising:
obtaining a message from a first user;
enabling the first user to amend a portion of the message to generate an amended message; and
displaying the amended message to a second user,
wherein the message is not displayed to the second user before the portion of the message is amended by the first user.

2. The method according to claim 1, further comprising:
determining the portion of the message to include a content of a predetermined type; and
notifying the first user to remove the content of the predetermined type in order to successfully display the amended message to the second user.

3. The method according to claim 1, wherein the first user and the second user are participants of a live stream.

4. The method according to claim 2, wherein the enabling the first user to amend the portion of the message to generate the amended message includes:
displaying a user interface to the first user;
obtaining, in the user interface, an amended portion from the first user;
replacing the portion in the message with the amended portion to generate the amended message,
wherein the first user does not need to retype other portions of the message.

5. The method according to claim 2, further comprising:
saving the message in a temporary memory space within the server until the message is amended by the first user.

6. The method according to claim 2, wherein the notifying the first user to remove the content of the predetermined type includes:
displaying a notification box to the first user;
determining the first user to have selected the notification box; and
displaying a message input interface containing the message to the first user.

7. The method according to claim 2, further comprising:
determining the content of the predetermined type, by a machine learning model, according to past messages from users on a live stream platform and past interaction data from users corresponding to the past messages,
wherein the first user and the second user belong to the users on the live stream platform.

8. The method according to claim 7, further comprising:
sending the determined content of the predetermined type to the first user.

9. A system for messaging, comprising one or a plurality of processors, wherein the one or plurality of processors execute a machine-readable instruction to perform:
obtaining a message from a first user;
enabling the first user to amend a portion of the message to generate an amended message; and
displaying the amended message to a second user,
wherein the message is not displayed to the second user before the portion of the message is amended by the first user.

10. A non-transitory computer-readable medium including a program for messaging, wherein the program causes one or a plurality of computers to execute:
obtaining a message from a first user;
enabling the first user to amend a portion of the message to generate an amended message; and
displaying the amended message to a second user,
wherein the message is not displayed to the second user before the portion of the message is amended by the first user.

11. The method according to claim 4, wherein
the message is obtained via a comment typing area in the user interface,
the notifying process includes displaying a notification message in the user interface,
the portion of the message is amended by the first user via the comment typing area in the user interface, and the amended message is displayed on another user interface displayed to the second user after the portion of the message is amended by the first user.

12. The system according to claim 9, wherein the message is obtained via a user interface displayed on a user terminal of the first user, the portion of the message is amended by the first user via the user interface displayed on the user terminal of the first user, and the amended message is displayed on a user interface displayed on a user terminal of the second user after the portion of the message is amended by the first user.

13. The non-transitory computer-readable medium according to claim 10, wherein the message is obtained via a user interface displayed on a user terminal of the first user, the portion of the message is amended by the first user via the user interface displayed on the user terminal of the first user, and the amended message is displayed on a user interface displayed on a user terminal of the second user after the portion of the message is amended by the first user.
